(19) United States
(12) Patent Application Publication
(10) Pub. No.: US 2021/0258025 A1
(43) Pub. Date: Aug. 19, 2021

(54) Dynamically tunable radio frequency filter and applications

(71) Applicant: Sam Belkin, San Diego, CA (US)

(72) Inventor: Sam Belkin, San Diego, CA (US)

(21) Appl. No.: 17/176,929

(22) Filed: Feb. 16, 2021

Related U.S. Application Data
(60) Provisional application No. 62/977,654, filed on Feb. 17, 2020.

(51) Int. Cl. H04B 1/00; H04B 1/30

(52) U.S. Cl. CPC H04B 1/0057; H04B 2001/307; H04B 1/0096; H04B 1/30

(57) ABSTRACT

A family of radio frequency (RF) filter circuits that use radio frequency linear mixers to controllably separate desired frequency spectrum from undesired frequency spectrum, and convert signals from one frequency to another, permitting inclusion in a closed- or open-loop control circuit that supports rapid dynamic manipulation of the filter circuit's center frequency and bandwidth.

### CROSS-REFERENCE TO RELATED APPLICATIONS

This application claims the benefit of priority of U.S. Provisional Application No. 62/977,654, filed 17 Feb. 2020 for Sam Belkin, which is incorporated herein by reference in its entirety.

### BACKGROUND OF THE INVENTION

### 1. Field

The present invention relates generally to radio frequency (RF) circuits and to the use of filters to separate or convert the spectrum of a complex RF signal.

### 2. Background

In the world of RF and microwave circuits, which includes broadcast television and radio, radar, cellular telephony, electronic warfare, and all other radios, as well as radio frequency signals transmitted via cable or optical means, a complex band of signals is captured by a source such as an antenna, making it necessary to select or reject (pass or suppress) portions of the applied spectra using filtering circuits, thus enabling focus upon those frequencies and signals from which meaningful information will be extracted or, in the case of transmitters, will be added. Most radio operations are at frequencies that are costly and technically challenging to manage and manipulate, and that challenge is particularly true when using filters to control spectra, so many known methods have evolved to convert those signals to parts of the spectrum where manipulation is less difficult and more effective. Virtually all such conversion methods involve nonlinear devices that distort the signal and generate unwanted, or spurious, signals that must be suppressed using filter circuits. Such suppression could occur on both sides of the desired signal band, passing a certain band containing a desired signal. The inverse is also true; the filter can suppress only a narrow band of frequencies, or a “notch”, while passing desired frequencies. Suppression can be applied to frequencies above the desired signal, by means of a low-pass filter. Suppression can be applied to frequencies below the desired signal, by means of a high-pass filter. Both of these suppressions can be simultaneously done with one bandpass filter. Overall system performance is often limited by the performance of such filters, the performance of which is inversely related to the system operating frequencies. The ability of a filter to precisely select frequencies to suppress (and therefore define frequencies to pass), is called “selectivity”, which can be expressed as Q (the Quality factor). Q is a dimensionless parameter that indicates the energy losses within a resonant element. One practical estimate of Q is the filter's center frequency divided by its bandwidth. In visual representations of filter functions, the more “vertical” the curve(s) or line(s) separating suppressed signals from passed frequencies, the higher the Q of the filter represented by the curve. The more precise the suppression of unwanted signals, the more selective and sensitive that radio circuit can be. Relative precision (Q) of the filter, or its efficiency in separating desired frequencies from other frequencies, has a major effect upon the overall performance of the radio circuit of which the filter is a part.

Goals of RF filter designers include improvement of precision, expressed as Q. RF filter designers also seek the ability to electronically tune the filter's center frequency over a wide frequency range, and to adjust the bandwidth of the filter. One major achievement in modern filter design is the ability to dynamically change such parameters via control signals from other parts of the circuit, enabling the overall circuit to support bolder performance goals, such as a radio circuit that controllably adapts to changing circumstances. A most laudable goal is the ability to clean a signal and shift it from the input frequency to any desired point in the spectrum. However, techniques in the prior art impose severe noise and other penalties upon systems that attempt to achieve such goals. A filter that can be rapidly adapted (tuned) to changing signal or circuit characteristics without adding significant noise is highly desirable.

Engineers seek a dynamically-tuned filter that permits manipulation of the center frequency and bandwidth via control signals from other points in the radio circuit, such as feedback or feedforward, or from external circuitry or manual control, while preserving optimal performance, signal integrity, and efficiency. They also seek fast dynamic filter tuning while maintaining the integrity of the desired signal and adding minimal noise. Another goal is to generate output signals from which spurious energy and noise have been suppressed without compromising performance of other parameters of the overall circuit.

Such capabilities are important when the radio designer seeks to generate as clean a signal as possible for use in other circuits. Radio frequency filters are often used to reduce a circuit's output to a very narrow band around the desired frequency, suppressing distributed noise and spurious signals. The inverse is true; filters are used to suppress narrow frequency bands that are undesired, passing the spectra on either side of that suppressed band. The degree to which a given filter circuit controls that band, and suppresses unwanted signal energy, defines the value of that filter in such applications and, often, the performance of the overall circuit of which the filter is a part.

Radio frequency filters have been the subject of focused engineering development since the inception of the electronics professions. In the superheterodyne radio, the subject of 1917 patent filings by Levy in France and then Armstrong in the United States, the circuit includes conversion of a high frequency input signal to a signal at lower frequencies that is more easily and economically manipulated. That requires steps of which most include a filter function to suppress unwanted frequencies while passing desired ones. Most modern radios use superheterodyne techniques. Over time, such circuits have become more complex and employ filters with more precision than possible in 1917, and those improvements comprise a vast body of prior art.

Some radios are defined by software (software defined radios, or SDR), but those designs typically use at least one stage of frequency conversion and filtering in the circuit. No advances in technology have eliminated the requirement for effective and controllable RF filtering.

### 3. Glossary

(Some Definitions are Specific to this Invention and this Document)

| | |
|---|---|
| Bandpass filter (BPF) | A filter that passes a defined band of frequencies, suppressing |
| | frequencies above and below that band. |
| Clean, cleaning | In the context of signal filtering, “cleaning” means removal or |
| | suppression of all components of a signal's spectrum other than |
| | specifically desired frequency(ies). |
| Controllable LO | A local oscillator, the frequency output of which can be manipulated |
| | by an external control signal. |
| Dynamically tuned filter | An RF filter, of which the output center frequency can be controlled |
| (bandwidth) | and the output bandwidth can be controlled, both by an external |
| | signal. |
| Dynamically tuned filter | An RF filter, of which the output center frequency can be controlled |
| (frequency) | by an external signal. |
| Feedback | A signal originating AFTER the point in the circuit where it is |
| | applied, thus permitting a closed loop including the controlled |
| | subsystem, component, etc. |
| Feedforward | A control signal originating BEFORE the point in the circuit where it |
| | is applied, allowing the manipulation of circuit parameters based on |
| | expectations or predictions, rather than measured performance. |
| Filter | A circuit that suppresses some radio frequencies and passes others, in |
| | accordance with its design. |
| Frequency synthesizer | A radio frequency circuit that inputs a frequency reference signal and |
| | outputs a signal at a controlled frequency. Synthesizers can be based |
| | on direct-analog, direct-digital, or phase lock loop circuitry, and some |
| | designs use combinations of those technologies. |
| Group delay | Phenomenon observed when multiple signals are applied in parallel |
| | to a channel, but appear at the output of the channel at different |
| | arrival times. |
| Highpass filter (HPF) | A filter that passes frequencies above a defined point, suppressing |
| | frequencies below that point. |
| Interferer | A spurious signal of sufficient magnitude as to degrade system |
| | performance |
| Intermediate Frequency | A general reference to the output frequency of a mixing or conversion |
| (IF) | circuit. |
| Local Oscillator (LO) | A signal generated by a source such as a crystal, crystal oscillator, |
| | frequency synthesizer, or the result of a signal generation process, |
| | used in the present invention as inputs to mixers. |
| Lower sideband (LSB) | One of the two major signal products of mixing signals; in this case, |
| | the LOWER (lower frequency band) of those products. |
| Lowpass filter (LPF) | A filter that passes frequencies below a defined point, suppressing |
| | frequencies above that point. |
| Microwave | A frequency band between 1000 MHz (30 cm) and 300 GHz (1 mm). |
| Millimeter wave | A frequency band between 30 GHz (10 mm) to 300 GHz (1 mm). |
| 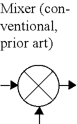 | A converter device to mix input frequencies, producing the sum of those frequencies, the difference between them, and (because it is inherently nonlinear), spurious signal energy. In the drawings of this document, the symbol at the left will represent a conventional mixer. |
| 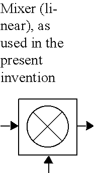 | A frequency mixer that does not add significant spurious energy to the output signal (because it is linear in the amplitude domain). In the drawings of this document, the symbol at the left represents a linear mixer, or LMIX. |
| 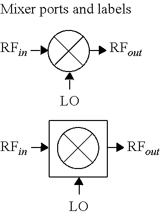 | In this document, some drawings show symbols representing frequency mixers, conventional or linear. In such symbols, the left, right, and bottom ports shall be considered to have the labels RFᵢₙ, IFₒᵤₜ, and LO respectively, as shown in the symbols to the left whether or not the labels appear. |
| Noise | Combination of unwanted discrete signals (spurs) and general (e.g. |
| | thermal) noise distributed across a significant part of the spectrum. |
| Notch filter | The opposite of a bandpass filter (BPF); the filter is configured to |
| | suppress a relatively narrow segment of the applied spectrum. |
| Passband | Frequencies other than those suppressed by the filter. |
| Quality (Q) | A dimensionless parameter to define filter performance, often |
| | estimated by dividing a filter's center frequency by its bandwidth. |
| Radio Frequency (RF) | Normally 1 MHz to 1 GHz, but for the purpose of this document, all |
| | frequencies from Extremely Low Frequency (ELF) to millimeter |
| | wave, including microwave bands. |
| Spectrum processing | The manipulation of spectra-RF energy. In the case of the present |
| | invention, it's achieved by simultaneously or serially manipulating |
| | multiple parameters (relative amplitude of spectrum components, |
| | phase, waveform, etc.) of the signal being processed. |
| Spectrum reversing | Changing a spectrum's orientation, ordinarily by subtracting signal |
| | from the LO. |
| Spurious signals, or | Discrete undesired signals generated by circuit elements and not |
| “spurs” | commanded or selected. |
| Stopband | Frequencies suppressed by the filter; frequencies other than those |
| | passed by the filter. |
| Tunable | In the context of this document, “tunable” refers to the ability to |
| | dynamically manipulate the center frequency of a filter's output, |
| | and/or its bandwidth. |
| Upper sideband (USB) | One of the two major signal products of mixing signals; in this case, |
| | the UPPER (higher frequency band) of those products. |

### 4. Prior Art

The term “radio frequency filter” (RF filter) comprises a very large family of circuits, used throughout RF engineering to separate passed (desired) from suppressed (undesired) signals. For example, spurious noise can be suppressed by filters while the input signal is passed. Filters are an important part of RF and microwave systems (for convenience, RF, microwave, and millimeter wave signals are all considered “RF” in the Glossary of the present invention). In RF engineering, four basic types of filters are identified by their effect upon the applied signal: lowpass filter (LPF), highpass filter (HPF), bandpass filter (BPF), and NOTCH filter. Conventional filter designs use passive devices, or combinations of passive and active devices, to achieve the desired effect, and add circuitry to compensate for the resulting nonlinearities, noise, insertion loss, and other problems of conventional filter designs.

The present invention is a family of RF filters. This document identifies devices and methods that are components of, or are used by, the present invention, but the present invention appears to be novel assemblies or combinations of such known components or devices.

There are filtering technologies that use mixers to shift signals from one part of the spectrum to another, because it is much easier to achieve required steepness of filter slopes (Q) and low insertion loss at lower frequencies.

What appears to be the first mixer-based filter design appeared in 1941: Uzwinsky V. I. Some methods of receiving radio waves while maintaining a constant phase, Journal of Theoretical Physics, USSR, 1941, v.XI, #1, 2. This technology comprises two mixers and a bandpass filter between them, plus a local oscillator (LO), to form a two-mixer filter cell.

Further, U.S. Pat. No. 8,126,418 of Feb. 28, 2012 by Nowak et al. for a Preselector interference rejection and dynamic range extension, and U.S. Pat. No. 8,855,591 of Oct. 7, 2014 also by Nowak et al. by the same name, both appear to be modern implementations of the mixer-based filter design, and discloses the use of solid state devices instead of the vacuum tubes available to Uzwinsky.

Whether Uzwinsky or Nowak, comparison with the present invention is warranted. As described in all of those references, the Uzwinsky/Nowak 2-mixer cells use a bandpass filter to clean signal spectrum outside the channel of interest and do not clean interferers inside the channel of interest, while the present invention filters one part of the signal spectrum at a time by using a filter (LPF or HPF) on one sideband (e.g. USB) of the downconverted signal, and then repeating the process with a second 2-mixer cell for the second part of the spectrum; the present invention uses linear mixers; separate filtering of the opposite parts of the signal's spectrum increases efficiency; manipulation of the LO signals controls the center frequency of the filter and the two edges defining that filter's bandwidth. This is all achieved while providing signal integrity and dynamic tuning, as well as low insertion loss.

U.S. Pat. No. 10,522,889 by Rowland et al. for a Tunable passive enhance Q microwave notch filter discloses a filter design by utilizing nonlinear circuit components that generally tend to contribute spurious noise to the output.

U.S. Pat. No. 10,468,360 by Smith et al. for an Integrated tunable filter architecture may be mostly differentiated from preceding filter designs by the level of integration achieved by the inventors. This filter is comprised of a series of filter functions on a single integrated circuit, with said filters modifiable by external circuitry and control signals. However, such filter designs generally include inherent L, C, and R parasitic values, which may cause latency. Further, such integrated filters include nonlinear devices that generally tend to add spurious noise to the process.

U.S. Pat. No. 10,389,395 by Hovda et al. for a Radio frequency active filter teaches a series of controllable local oscillators, mixers, and filters to provide a filter function with controllability. Use of conventional mixers generally tends to introduce a high level of spurious noise. Insertion losses could add the requirement for additional amplification, with recognized penalties that may be imposed by the circuitry.

Prior art filters that use various well-known passive and active circuits, and all those that use prior art mixers, typically add noise signal due to nonlinearity of the mixing circuit, because nonlinearity has been understood to be an inherent and fundamental characteristic of all mixers. RF engineering literature defines a mixer as “ . . . a nonlinear device that . . . ” In nonlinear devices, unavoidable spurious signal products limit the performance of the design, and therefore of all filter designs that use conventional nonlinear mixers.

Problems of prior art filters in general include complexity/cost required to achieve high Q with low noise, a lack of tuning agility (center frequency and bandwidth), high insertion loss, the inability to mitigate group delay, and the inability to address interferers in adjacent channels.

The present invention is differentiated from prior art by circuit architecture and component selection, which includes the use of linear mixers to efficiently move signals to a desired part of the spectrum where filter performance is optimized, and then to return those signals to the original part of the spectrum or to any new part of the spectrum depending upon control signals applied to the LOs that control the parameters of said mixers. In one embodiment, it involves the use of a low pass filter (LPF) to remove extraneous energy from one side of the spectrum, then reverses the spectrum, and then uses a second LPF to remove undesired signal energy from the other side of the spectrum, with the use of synchronized adjustable frequency synthesizers as local oscillators (LO) applied to the mixers, thus permitting tuning of the filter parameters. That process becomes practical because it uses linear mixer circuitry, thus adding insignificant spurious signal energy and imposing little insertion loss, permitting improved suppression of undesired signals and also enabling rapid and precise tuning of filter parameters that can be controlled by automated or manual methods. One family of linear mixers, and the only such technology found in the literature, is described in commonly-owned U.S. Pat. No. 10,622,946 of 14 Apr. 2020, by Belkin. That mixer architecture uses linear devices such as field effect transistors (FETs), switches, or attenuators as LO-controlled variable gain channels comprising mixer channels that avoid LO current within the mixer circuit, achieving significantly higher IP3 numbers, lower insertion loss, and better LO-to-output isolation than other technologies. Derivatives of that new mixer technology are used in unique circuits and configurations comprising the present invention, together with other known devices and subsystems such as conventional bandpass, lowpass, highpass, and notch filters, plus amplifiers, attenuators, oscillators, and frequency synthesizers.

Prior art technologies typically include many frequency converters, or mixers, including the linear design by Belkin, already cited. However, nothing was found in the prior art in which the frequency spectrum conversion process was accompanied by filtering to optimize signal quality.

### 5. Objectives of the Present Invention

The present invention is intended to overcome problems with, and add capabilities to, radio designs in general, and RF filter technology in particular, by permitting the rapid and precise tunability of operating characteristics of RF filters and reducing the noise generated in conventional radio circuitry, thus enabling the optimization of radio circuits in which the present invention is adopted.

One objective of the present invention is to provide RF filters with improved Q, thus achieving improved selectivity compared to filters of the prior art.

Another objective is to overcome problems with conventional filters by shifting an input RF signal to a lower frequency where filter functions are more efficient, and then returning the signal to a controllably higher frequency at which it can be applied to other circuitry as a filtered and improved signal.

Another objective of the present invention is to provide RF filters able to clean input signals, outputting them at the same or a controllable different frequency but with lower noise than in the original signal, all with greater precision and lower noise and insertion loss than is possible with techniques of the prior art.

Another objective is to provide RF filters that enable dynamic manipulation of filter center frequency and band or notch width, or the relationship between passband and stopband.

Another objective is to provide RF filters that enable dynamic manipulation of the amplitude of the output signal.

Another objective is to provide dynamically tunable filters the characteristics of which are controllable by feedback or feedforward signals from other points in a radio's circuit, or by external manual means.

Another objective is to provide a family of frequency converters with lower added noise and lower insertion loss than prior art technologies.

Another objective is to provide a family of RF filters with integrated controllable phase shifting, able to equalize group delay.

Another objective is to provide a family of RF filters that support suppression of spurious noise or interference in adjacent channels.

Another objective is to provide a dynamically tunable filtering system that is capable of providing spectrum separation(s) and performing the spectrum processing functions.

### BRIEF SUMMARY OF THE INVENTION

The present invention comprises a family of radio frequency filters using linear mixers and controllable frequency synthesizers connected to those mixers as local oscillators, in circuit configurations that permit the manipulation of radio frequency spectra while adding minimum noise and spurious signals, and some applications thereof.

Further, the present invention uses components, including said linear mixers, with very low insertion loss. The combination of low noise and low insertion loss permits cascading or combinations of mixer/filter circuits not possible with conventional designs. For example, without compromising signal integrity, the present invention can provide rapid dynamic tuning, or manipulation, of the center frequency and bandwidth of the filter, including bandpass designs and notch designs. It can also be used to clean signals without compromising dynamic tuning or other features, providing noise suppression so complete as to permit new approaches to radio system design. It can also be used to clean signals and simultaneously convert them from one point in the spectrum to another.

One embodiment of the basic circuit of the present invention is comprised of known circuit components that: input the RF signal, convert it via a mixer to another frequency, use a conventional filter to clean one side of the spectrum, reverse the signal spectrum, use a second conventional filter to clean the other side of the spectrum, and reconvert the cleaned signal to the original part of the spectrum, with all frequency conversions achieved using controllable local oscillator(s) signal(s) that can be varied in frequency to achieve dynamic tuning of the filter's characteristics. In addition to the ability to clean either or both sides of a signal, variations can operate as HPF, LPF, BPF, or notch filters.

Combinations of the basic circuit of the present invention create a family of dynamically tuned filters that support advanced radio circuits not possible with filter designs of the prior art. Such performance is achieved using RF mixers that are linear in the amplitude domain and have low insertion loss, together with fast-switching signal sources such as direct-digital synthesizers (DDS) or a DDS plus phase locked loop (PLL) synthesizer, as the mixers' controllable local oscillator(s) (LO). Such filters are capable of rapidly responding to frequency control signals, to changes in signal characteristics, to extraneous signals, and to operational commands whether input via manual means or in response to an automated electronic control signal such as feedback or feedforward. A dynamically-tuned filter such as the present invention can be included in a closed loop of automated control, enabling other components in that loop to adjust filter parameters. That loop circuit can include automated control from feedback or feedforward sources, or from manual input, permitting very rapid optimization of filter parameters. The overall result supports RF system performance not achievable in designs limited to the filter techniques of the prior art.

Implementations of the present invention can be adapted to unique requirements of the system or the circuit by applying to at least one mixer a control signal comprising a task-specific, specially-designed waveform. The principle is clear to one skilled in the art, who will understand that the number of possible applied waveforms is infinite. Therefore, the possibilities are neither enumerated nor described.

### BRIEF DESCRIPTION OF THE SEVERAL VIEWS OF THE DRAWINGS

FIG. 1 depicts the simplest embodiment of the present invention, a single 2-mixer filter cell comprised of a mixer, a conventional filter, a second such mixer, and controllable local oscillator (LO) signal(s) applied to both mixers.

FIG. 2 depicts an embodiment of the present invention with spectra defined, in which the input signal is cleaned and also shifted to a controllable different output frequency.

FIG. 3 depicts the present invention as two 2-mixer cells in series, with spectra quantified and with spectrum reversed.

FIG. 4 depicts a 2-mixer cell as a notch filter.

FIG. 5 depicts an embodiment with an equalizer to mitigate group delay.

FIG. 6 depicts an embodiment with tunable phase and amplitude, configured to suppress interference into an adjacent channel.

FIG. 7 depicts an embodiment without spectrum reversing.

FIG. 8 depicts the result of controllable center frequency and bandwidth.

FIG. 9 depicts the efficiency of the two 2-cell embodiment; effectively, Q-factor.

FIG. 10 depicts the ability of the present invention to tune bandwidth.

FIG. 11 shows the effect of variable LOs in a two 2-mixer embodiment.

FIG. 12 shows the effect of managing the cutoff frequencies of two filters (LPF and HPF or HPF and LPF) to create precise notch and bandpass filters.

Some of the figures are block diagrams, provided as tutorial and enabling representations of various embodiments of the invention whether or not they are also discussed in the text. Articles depicted in the drawings are not necessarily drawn to scale. Where useful to enhance clarity and enablement, frequency definitions—often normalized—are provided. In most drawings, a BPF is added to the inputs and outputs of the present invention, not as a part of the invention itself, but to comply with common engineering practice to limit the subsequent circuit to the frequency range of interest. The figures are provided for the purpose of illustrating one or more embodiments or applications of the invention, and not to limit the scope or the meaning of the claims.

### DETAILED DESCRIPTION OF THE INVENTION

In the following description, numerous specific details are set forth in order to provide an enabling understanding of radio frequency filter designs that embody principles of the present invention. To one skilled in the art, most of the figures provide sufficient description as to enable practice of the invention. Also, one skilled in the art may practice the invention without some specific details and with minor variations of the circuitry, while remaining within the bounds of the invention. Throughout this description, the embodiments and examples shown should be considered as exemplars, rather than as limitations on the invention. That is, the following description and attached figures show various examples for the purposes of illustration. However, these examples should not be construed in a limiting sense as they are merely intended to provide examples of the invention and its applications rather than to disclose all possible implementations of the present invention.

Unless defined otherwise in the included Glossary, all technical and scientific terms used herein have the same meaning as is commonly understood by one with skill in the art to which this invention belongs. In the event the definition in this document is not consistent with definitions elsewhere, the definitions set forth in this document and its Glossary will prevail.

Specific embodiments of the invention will now be further described by the following, non-limiting examples which will serve to illustrate various features. The examples are intended merely to facilitate an understanding of ways in which the invention may be practiced and to further enable those with skill in the art to practice the invention. In addition, reference throughout this specification to “one embodiment” or “an embodiment” means that a particular feature, structure or characteristic described in connection with the embodiment is included in at least one embodiment of the present invention.

One embodiment of the present invention uses combinations of linear mixers, filters, and controllable or fixed local oscillators to improve an input signal, such as from a broadband antenna, of which one possible function of several is the removal or suppression of extraneous noise from that signal. Implementations of the present invention permit rapid controllable change of the filter's center frequency and bandwidth, while optimizing signal integrity and adding little noise to the process. Other embodiments of the present invention add controllable attenuators, phase shifter(s), and switches to the basic circuit, expanding its function beyond filtering to permit complex spectrum processing. The present invention allows the designer to rapidly and precisely shift the manipulated spectrum along the frequency axis, without adding significant noise from nonlinear devices in the circuit. By making such frequency changes, the present invention operates much like a frequency converter, or mixer, but with lower noise.

In the examples shown, frequency labels or normalized data are provided to facilitate understanding of functionality, and should not be construed as limiting characteristics of the invention, which can be practiced using any frequency band or spectrum in the radio frequency or microwave bands.

Some means of practicing the current invention are clearly taught by the block diagrams in the figures; text explanation is unnecessary. To enhance clarity and improve enablement, some figures show example frequencies.

Signals may be amplified or suppressed by modifying the spectra in the frequency domain. Filtering does it in frequency and amplitude domains. Mixers do it mostly in the frequency domain and the phase domain. All these circuits work in one or two domains and may be considered as one or two dimensional processes. The present invention allows designers to consider multi-domain or multidimensional spectrum processing, via filters and mixers.

If the application is only filtering, a single LO frequency can be applied to both mixers. With separate tuning of LOs, the output can have asymmetrical bandwidth. When the present invention is configured as a frequency converter, the input frequency is not equal to the output frequency by definition, and bandwidth parameters are the same as for “filtering only” configurations.

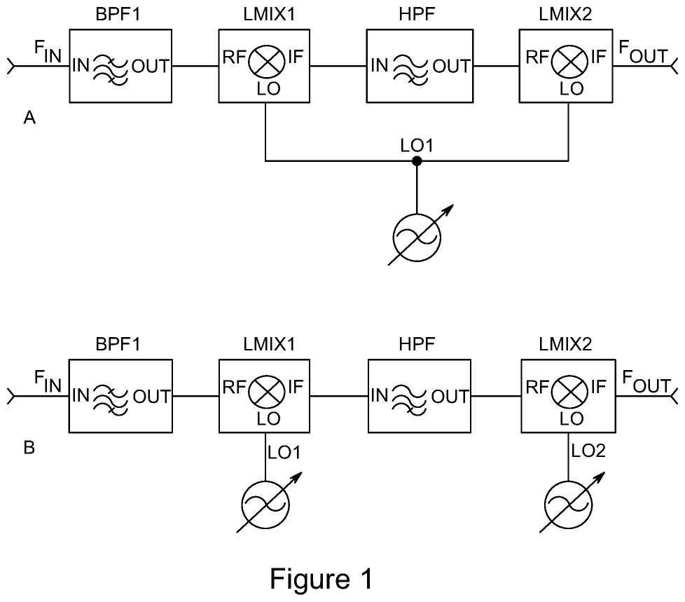

FIG. 1. Dynamically tuned filter with two mixers and one filter (the figure shows an LPF).

The input RF signal (Fin or Frf) is applied to the RF port of LMIX1 either directly or via a BPF to limit broadband interferers. The output of a frequency synthesizer comprising local oscillator LO1 is applied to the LO port of LMIX1. The output IF port of LMIX1 is connected to a filter (BPF, LPF, HPF, NOTCH), the output of which is connected to the RF input port of the second linear mixer LMIX2. LO2 is applied to the LO port of mixer LMIX2, the output of which can be the same frequency as Frf but at lower noise levels, with two fixed-frequency LOs or two controllable LOs each controlled by separate and different control signals or by a common control signal. Center frequency of that output can also vary if LOs are variable, and bandwidth of that output can vary if LOs are independently controllable. FIG. 1A shows the simplest such embodiment with a common LO, and 1B shows that embodiment with separately-controllable LOs.

This embodiment of the present invention is designed to remove noise and spurs from an input signal (such as from an antenna, whether or not amplified), while providing agility that permits adaptation to frequency changes in that input signal.

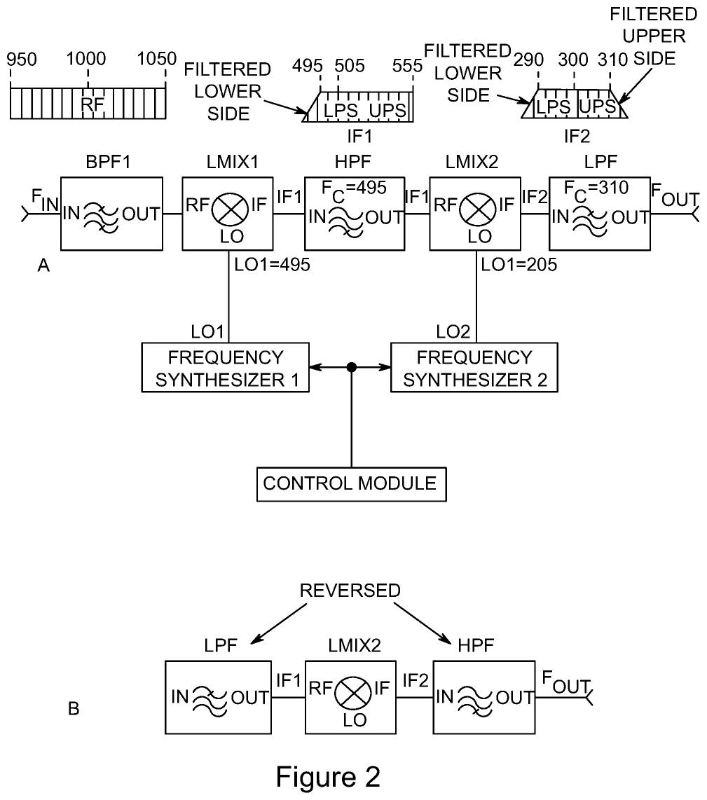

FIG. 2. Dynamic tunable filter and converter with HPF and LPF and synchronized LOs.

Downconversion is shown in this figure; however, it may be any conversion, e.g., down- or up-conversion, with the same filtering effects. In this embodiment, the input signal undergoes preliminary filtering by a broadband BPF, then is downconverted by LMIX1 to a lower point in the spectrum for efficient cleaning of one side of the spectrum by an HPF. The signal is then upconverted by LMIX2, the output of which passes through an LPF to clean the other side of the spectrum. Each mixer is independently controlled by an LO signal from a frequency-agile frequency synthesizer. The controllable local oscillators are at different frequencies as shown, producing an output signal that has been cleaned and also is at a controllable different frequency than the input. The same circuit with similar frequency planning can be used with an LPF in the first position and an HPF in the second as in FIG. 2 B.

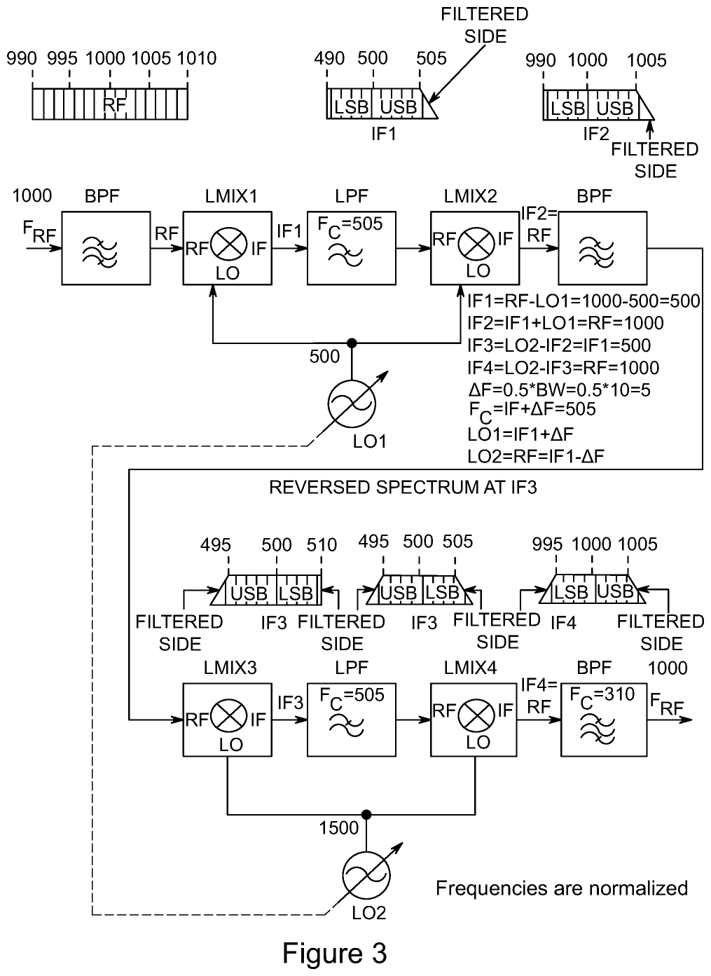

FIG. 3. Dual 2-mixer cell filter.

This embodiment comprises two 2-mixer filter cells, with broadband BPFs to limit distant interferers. The first 2-mixer cell downconverts the signal to a lower frequency, at which the upper side of the spectrum is filtered with an LPF. The signal is then upconverted by LMIX2. After that first 2-mixer cell, the signal enters the second two-mixer cell and is again downconverted by mixer LMIX3 to an intermediate frequency IF3 equal to the central IF1. The RF signal is subtracted from the LO signal; therefore, the resulting IF3 spectrum reverses and the LSB of the initial RF signal becomes the USB at the IF3 line. This side of the spectrum was not filtered in the first 2-mixer cell and is therefore filtered by the second cell LPF. Then mixer LMIX4 returns the signal from intermediate frequency IF3 to the IF4 that is equal to the initial input RF frequency. The signal spectrum reverses again and becomes identical to the input, but minus noise. This signal may be filtered by a wideband BPF, filtering possible unwanted products from conversion process.

The input RF spectrum has one side (USB) filtered in the first two-mixer cell, then its spectrum is reversed and its LSB is filtered in the second two-mixer cell. Therefore, the RF signal is cleaned symmetrically from both sides at lower frequencies, using LPFs of high-quality with linear phase characteristics and low insertion loss.

The choice of the LO frequencies is important. For the first LO1, it can be defined as

F_{LO1}=Fc_{RF}−IF1+ΔF (1)

where: Fc_{RF} is the central frequency of the input RF signal, IF1 is the first intermediate frequency, ΔF is equal to 0.5BW and is the frequency shift in LO1 and LO2 frequencies that create the difference 2 ΔF=BW between two LOs.

The second LO2 frequency will be equal to

F_{LO2}=Fc_{RF}+IF3−ΔF (2)

Equations (2) and (3) show that the difference between two LO frequencies is equal to double the ΔF value that is equal to the filter bandwidth BW. A shift in the LPF cutoff frequency also adds to the filter bandwidth, so it is equal to double ΔF plus cutoff shift. Adjusting the ΔF value changes the filter bandwidth accordingly, though one frequency unit change in ΔF results in two frequency units change in the bandwidth. Changing the ΔF from 0 to the value of 0.5BW will change the filter's bandwidth from 0 to the full BW value. Synchronous tuning of the frequencies of the LOs will tune the filter's central frequency. Changing the ΔF for both LOs equally will change the bandwidth symmetrically. Changing the ΔF separately and unequally for LO1 and LO2 will change the bandwidth asymmetrically and can be used when useful. Therefore, this embodiment of the present invention allows dynamically tunable filtering with electronically controlled parameters.

In all embodiments, including those shown and reasonable derivatives thereof, factors that differentiate the present invention from the prior art include dynamic control over filter parameters, separate filtering of each spectrum side, low insertion loss, and the ability to dynamically adjust the center frequency and bandwidth while minimizing noise added to the signal.

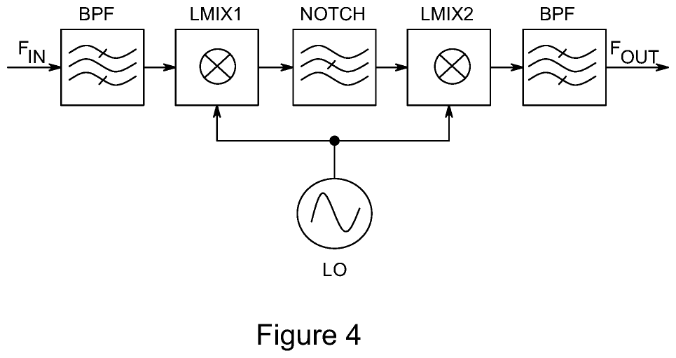

FIG. 4. Notch filter.

The input signal is cleaned from distant interferers by a broadband BPF, then is downconverted to a lower frequency by LMIX1. It then passes a conventional notch filter (which is more effective at lower frequencies), and is upconverted by LMIX2. In that figure, both linear mixers are controlled by the same LO, and if two LOs are provided and the LO applied to LMIX2 varies, the circuit acts as both a notch filter and a frequency converter. A final broadband BPF reduces the effects from possible unwanted distant products.

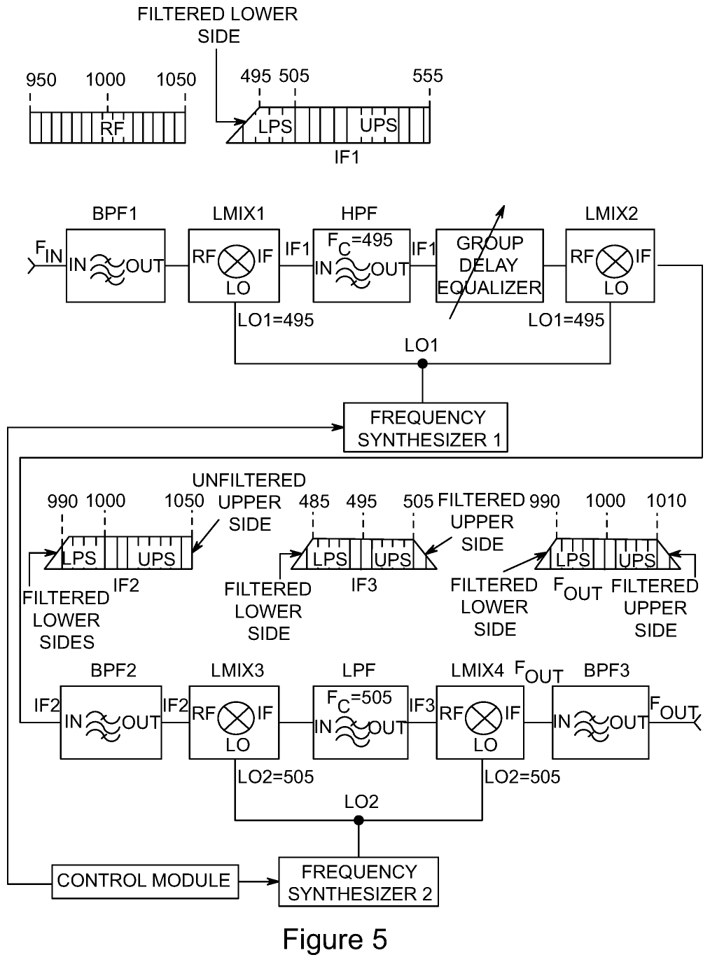

FIG. 5. Mitigation of group delay.

The input signal is cleaned from distant interferers by broadband BPF1, then downconverted by LMIX1 and passed through an HPF to clean one side of the spectrum, then passes a known group delay equalizer. It is then upconverted to the original point in the spectrum by LMIX2 and cleaned by broadband BPF2. It is then downconverted by LMIX3 and the other side of the spectrum is cleaned by an LPF, after which the signal is upconverted to the original point in the spectrum and passed through a broadband BPF to remove possible distant conversion products. LMIX1 and LMIX2 are controlled by frequency synthesizer 1, and LMIX3 and LMIX4 are controlled by frequency synthesizer 2, with both synthesizers controlled by a common control unit. When LO4 frequency does not equal LO3 this configuration becomes a frequency converter.

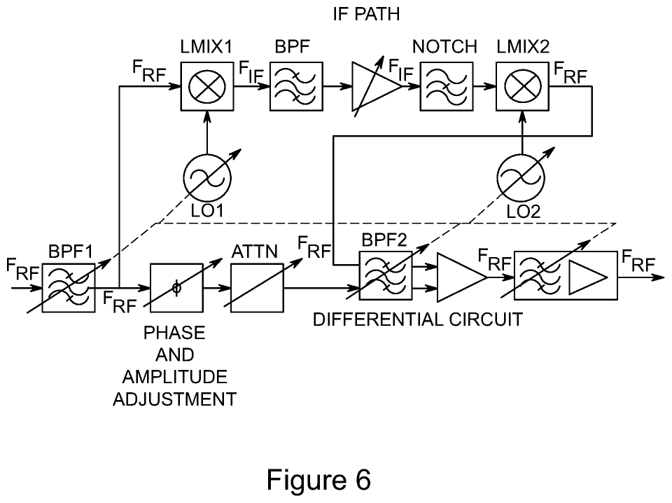

FIG. 6. Dynamically tunable filter for suppression of interference into an adjacent channel.

The signal is initially filtered by a controllable broadband filter BPF1, then is split with one channel routed to known phase control and amplitude control circuits, while the second channel is converted to a lower frequency by LMIX1, filtered by broadband BPF3, amplified controllably, passed through a notch filter that removes the desired channel spectrum, and then reconverted to the initial frequency by LMIX2. The two channels pass through the differential circuit comprised from controllable BPF2 and an amplifier, where they are combined, then filtered, and then amplified. BPF1, BPF2, and the two LOs, are controllable and synchronized.

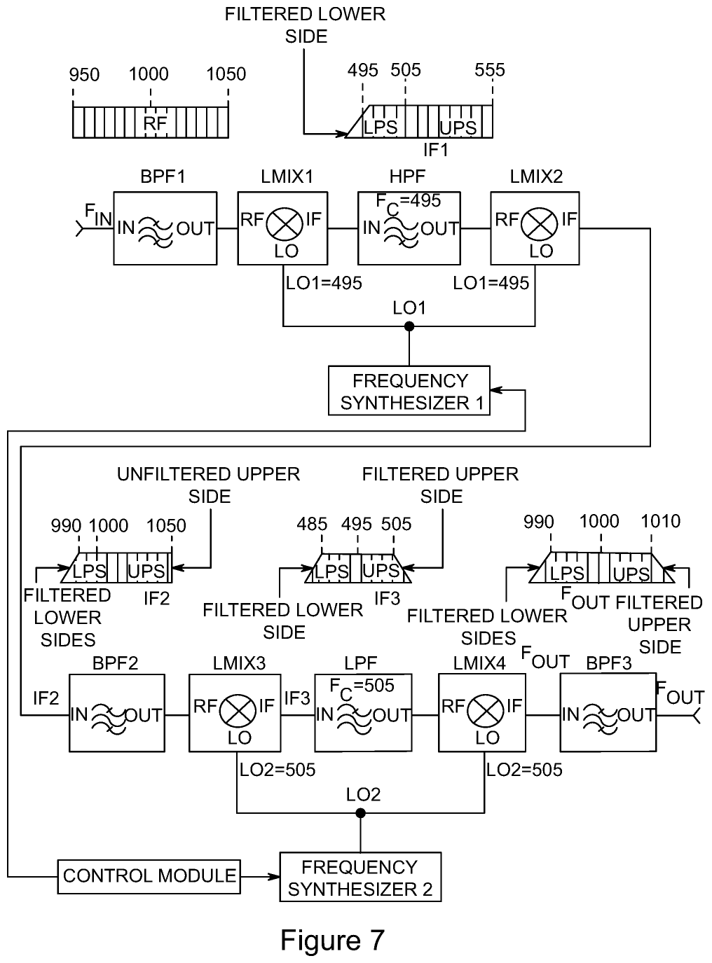

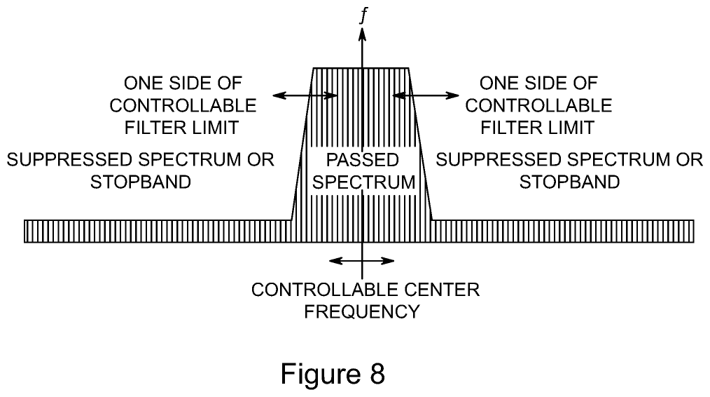

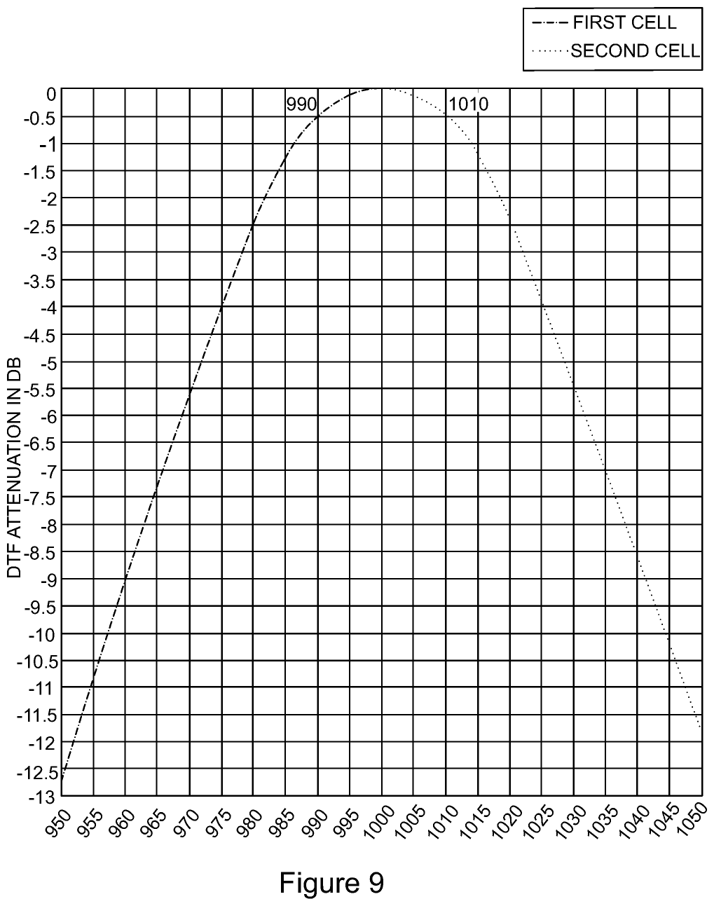

FIG. 7. The present invention shown without spectrum reversing.
FIG. 8. Depicts the effect of controllable center frequency and controllable bandwidth, achieved with the present invention.
FIG. 9. Illustration of filtering effect of two 2-mixer cells connected in series

Shows attenuation vs offset frequency by an HPF in a first 2-mixer cell, then by an LPF in a second 2-mixer cell.

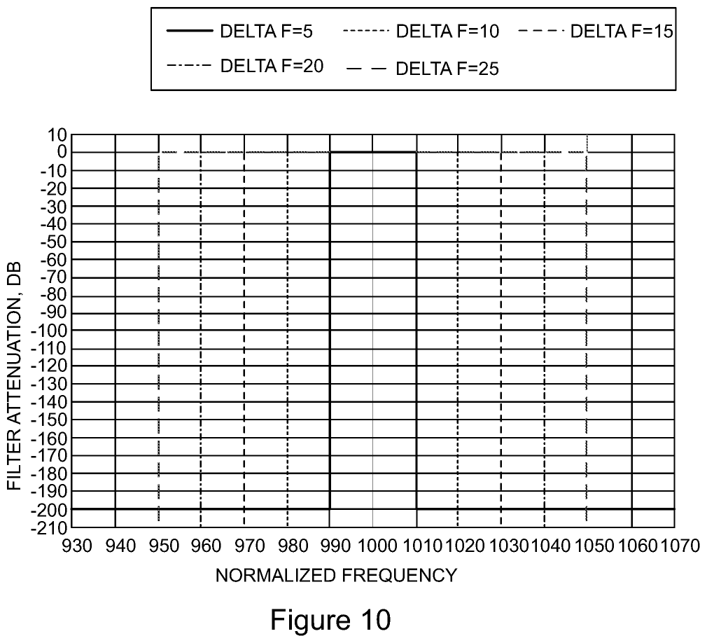

FIG. 10. The present invention with dynamically tunable bandwidth

Shows performance of bandwidth agility with ΔF change.

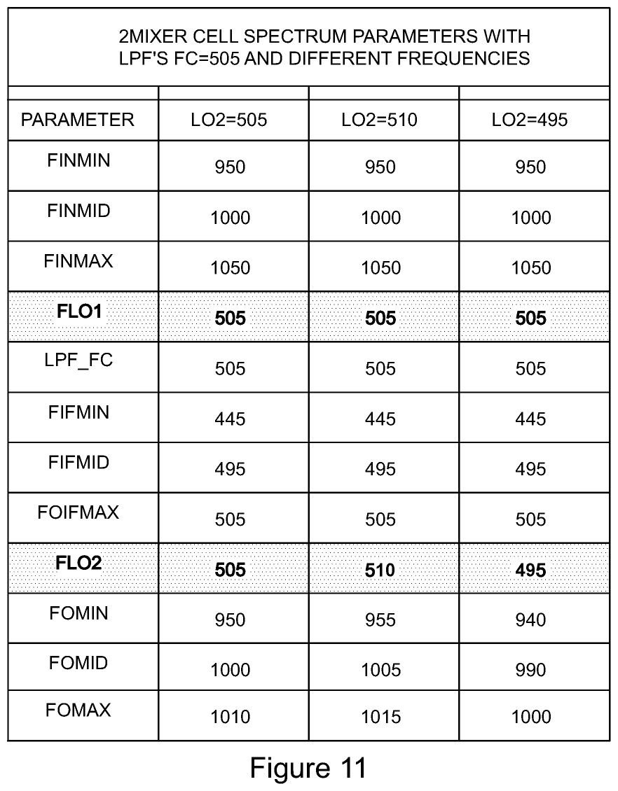

FIG. 11. Example of the effect of varying LO frequency in a two 2-cell filter embodiment

Shows changes in internal and output frequencies as LO frequencies vary.

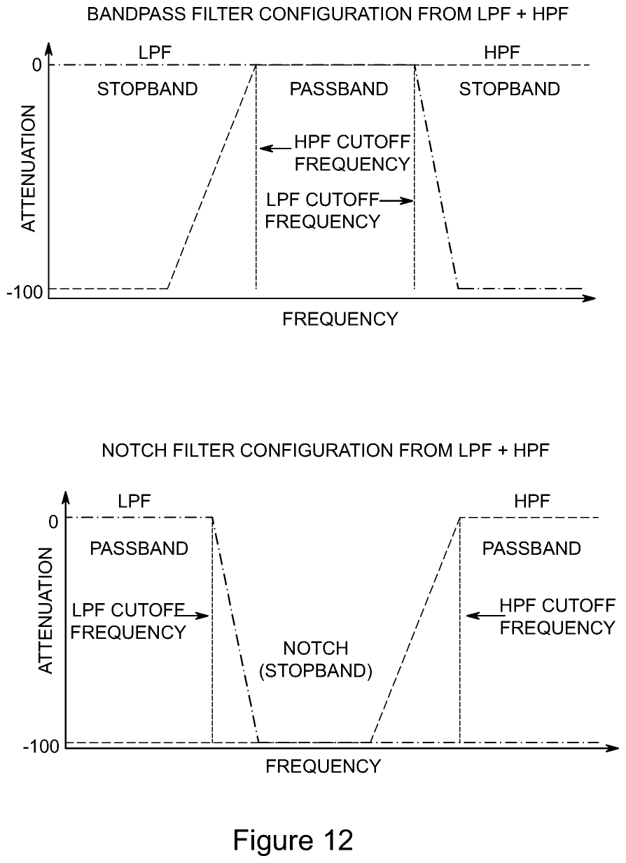

FIG. 12. Using an LPF plus an HPF of the present invention, with frequency planning to create precise bandpass filters (with overlap of cutoffs) and notch filters (with separation of cutoffs).

### Variations

Mixer Quality.

The present invention can be executed using mixers of the prior art, though signal quality will be degraded by conventional designs due to spurious signals generated by inherent nonlinearities, and to the increased insertion loss which may require amplification.

Fixed Frequency.

The dynamically tunable filter of the present invention can be useful without tunability, by using fixed-frequency LOs controlling the mixers, and the other advantages of the present invention—noise, insertion loss, precision—will be retained.

Gain Equalization.

The dynamically tunable filter of the present invention permits separation of the spectrum of the signal into multiple channels, with separate gain control of each of those channels, without the penalties of such a circuit using conventional filtering.

Sequence/Order of Filters.

In many configurations of the present invention, conventional lowpass and highpass filters appear one after the other in the signal path to clean both sides of the signal spectrum. In most cases, the order of the LPF and HPF can be reversed.

Control Waveforms.

The mixers of the present invention can be controlled by local oscillator circuits that produce waveforms that have been designed for a specific application. The use of such custom waveforms can optimize performance, depending upon other circuitry and the purpose of the overall filter. Obviously, that creates an infinite library of possibilities so enumeration and description cannot be provided.

General.

Any filter circuit comprising a linear or conventional mixer that shifts all or part of the signal to a new frequency, with a conventional filter to clean one side or both sides of the signal at the new frequency, and a second linear or conventional mixer that shifts all or part of the resulting signal to another frequency, should be considered within the scope of the present invention whether the overall circuit is tunable (controllable LO or LOs) or fixed.

### Practice and Applications of the Present Invention

Filters to Improve Signal Quality.

The present invention is a low-noise radio frequency filter with low insertion loss, controllable agility of its output center frequency and bandwidth, and better linearity of phase characteristics and lower amplitude ripple.

Notch Filter.

This filter can suppress a controllable frequency band within the signal applied to it. The present invention permits such a filter with very high Q. Derivatives of the basic design of the present invention permit tunability of the center frequency and bandwidth of the notch. In addition to the notch filter configuration in which a conventional notch filter appears between two mixers, the 2-mixer cells with LPF and HPF can form a high quality notch filter when the cutoff frequency of LPF is chosen to be lower than the cutoff frequency of the HPF.

Bandpass Filter.

This filter can suppress all but a controllable frequency band within the signal applied to it. The present invention permits such a filter with very high Q. Derivatives of the basic design of the present invention permit tunability of the center frequency and bandwidth of the passband. The 2-mixer cells with LPF and HPF can form a high quality bandpass filter when the cutoff frequency of the LPF is separated from the cutoff frequency of the HPF.

Mitigation of Group Delay Distortion.

Group delay is a complex, completely artificial term. It was discovered when the first cable-based communications systems were introduced. Engineers discovered that groups from different parts of the spectrum arrived at the destination point at different times. The higher the frequency of the group, the more time latency of components of the group.

In actual RF systems, group delay results in errors in received data, degrading the Bit Error Rate (BER) parameter. Therefore, group delay is a harmful phenomenon and must be minimized. Group delay may be considered as the rate of the signal phase change. Therefore, by adjusting phase distortion in the required frequency range the negative effect of group delay can be mitigated.

Because the present invention can separate the signal spectrum on lower and upper spectrum parts and develops them separately, there is an opportunity to include a group delay equalizer into one of these circuit paths, reducing the harmful effect of group delay. Because the high-frequency part has a more pronounced delay, it is preferred to include known equalization means into the lower frequency part. In this case, it is easier to manipulate the delay and shift timing to be closer to the high-frequency path. The group delay mitigation function can be added to the 4-mixer (two 2-mixer cells) configuration of the present invention. The present invention allows separation of the signal spectrum parts, therefore, adjusting the phase difference between these parts is achieved by placing adjustable attenuators and phase delay units in the lower spectrum part of the circuit. These tunable components will adjust the phase to minimize the total group delay difference between the lower and upper parts of the signal spectrum. Today there are no other known methods for the active mitigation of group delay effects. Only passive measures are available, such as selecting filters with maximally flat phase characteristics. The present invention enables precise mitigation of group delay influences as shown, using this embodiment.

Frequency Converter Using Dynamically Tunable Filtering.

The present invention can be used as a low noise and low insertion loss frequency converter by varying LO frequencies, and in such use will have better performance than other frequency converter designs in the prior art.

Test Equipment.

In non-radio applications such as test equipment and scientific instruments, the present invention will improve performance because it permits higher circuit sensitivity and selectivity with lower noise, thus enabling the detection, manipulation, and analysis of signals at lower levels than is possible with prior art technologies.

Dynamic Filter to Suppress Interferers in an Adjacent Channel.

In the case when strong interferer(s) into adjacent channels exist, the dynamic filtering system can be used. The RF signal from the input (typically the antenna) is applied to the relatively broadband preselection filter BPF1, which is wide enough to allow a group of several channels, and then to conventional phase and amplitude adjustment circuits. Simultaneously, RF signals from BPF1 are applied to the ancillary IF path, which includes the first linear mixer, IF filter and variable gain amplifier, notch filter, and the second linear mixer, with both linear mixers connected to LOs that are synchronously tuned. This application and embodiment works as follows.

The first linear mixer converts the signal from preselector BPF1 to the IF circuit path wide enough to pass a few low side adjacent channels, and a few high side adjacent channels. Then the notch rejection filter suppresses the desired channel from the IF circuit path spectrum. Only a few adjacent channels from the low side and high sides go to the second mixer and convert back to the initial frequencies. To get good suppression and low distortion into adjacent channels the IF frequency should be low. Then signals from phase and amplitude adjustment circuits and the ancillary IF path enter into differential filtering and amplifying cascades. By adjusting the phase and amplitudes, all signals in adjacent channels are suppressed and only the desired channel appears at the system output.

In this embodiment and application the LO oscillators LO1 and LO2 are typically at the same frequency, but it may be helpful to slightly tune one of the LO frequencies in order to get better compensation of the signals into the differential amplifier. In all such cases, the two LO frequencies must be synchronized. These circuits do signal vectors compensation by summation of them with the opposite phase and equal amplitudes. Such two 2-mixer cells can be configured to provide a dynamically tunable notch filter with tunable notch bandwidth and improved suppression of interferers.

The present invention can be used to create bandpass and notch filters with performance not attainable using other technologies, and even beyond the performance of preceding filter configurations. Two filters in accordance with the present invention (LPF and HPF) can be connected in series and in either order. Frequency planning to overlap the filter cutoffs will create a highly precise bandpass function, while frequency planning to separate the cutoffs will create a highly precise notch function.

Component Selection.

In executing the present invention, achievement of its potential for signal integrity and dynamic tuning depends upon careful component/device selection, and such selection criteria and methods should be considered a part of the present invention. One reason for setting such difficult selection criteria is that the sensitivity of radio circuits using the present invention are at a previously unattainable level, so components/devices that generate noise at levels that would be insignificant in conventional designs may not be acceptable in the execution of the present invention.

The tunable filter of the present invention has the same LO requirements as the receiver's mixers; the LO signal must be stable and clean of spurs and other noise, and components used in generating LO signals for the present invention must be carefully selected. LO spurs will create extra unwanted spurs at the converter output. The same is true for other noise applied by LOs to the converters. However, the nature of the selected linear mixer does not allow LO current to flow through the mixer circuit, which removes another source of noise.

The thermal noise floor density level for the converter is Pnoisedens=kTB, where k is the Boltzmann constant, k=1.381*10\hat{ }-23 J/K; Tis the system temperature in degrees Kelvin; B is the system bandwidth in Hz. For T=290° K (room temperature) the noise power density becomes Pnoisedens=4*10\hat{ }-21 W/Hz or −174 dBm/Hz. This value is an RF industry standard. To that, the circuit designer must add the noise from the LO. Two uncorrelated noise signals are added by the superposition mathematical summation method to calculate total noise power. This additional level is considered to be limited to about 0.5 dB. This will be the maximum allowable degradation of the noise level in the RF system due to energy addition by the LO. That level of about 0.5 dB corresponds to an additional noise power level about 10 dB lower than the existing noise floor. It means that for 0.5 dB allowable elevation of the noise floor the second noise source (LO noise) must be 10 dB below the converter noise floor. Noise elevation will be 0.46 dB in this case, substantiating 0.5 dB as a useful approximation.

In designing a frequency converter with 1 MHz bandwidth, the noise floor of the converter is −174 dBm/Hz+10*log(1 MHz/1 Hz)=−174 dBm/Hz+60=−114 dBm/Hz. For a converter when B=10 MHz, it will be −104 dBm/Hz; for B=100 MHz-94 dBm/Hz, and so on. Accordingly, the maximum allowable noise contribution from the LO will be 10 dB less or −124 dBm/Hz, −114 dBm/Hz, and −104 dBm/Hz. The situation with spurs is statistical, so it is not possible to create exact numbers for all possible situations. Fortunately, LO spurs can be additionally suppressed by the mixer, especially if it is a member of the new generation linear mixers, and by series BPFs when applicable. Further, the filter of the present invention uses linear mixers in which the LO is at two times lower frequency, which facilitates separation of LO energy from RF energy, and will permit a well-balanced mixer circuit with overall superior filter performance.

The LO can be generated using a crystal or multiple crystals, but that device is an oscillator and does not produce a sinusoidal waveform, so each period of its output signal can be different, and the output can include excessive spurious energy. Some prior art techniques use crystals followed by a filter to clean the LO signal, but the result may not be adequate for optimization of the circuitry of the present invention.

All embodiments are shown with tutorial block diagrams showing circuit design using components and devices that are generally known or published, and where needed are supported by text description and descriptive mathematics to improve enablement.

### CONTENT AND LANGUAGE

The terms “including,” “comprising,” and variations thereof as used in the claims should not be interpreted as being limitative to the means or elements listed thereafter. Thus, the scope of the expression “a device comprising A and B” should not be limited to devices consisting only of components A and B. It means that with respect to the present invention, the only relevant components of the device are A and B. That is, the terms “including”, “comprising” and variations thereof mean “including but not limited to”, unless expressly specified otherwise. Thus, use of the term “comprising” indicates that the listed elements are required or mandatory, but that other elements are optional and may or may not be present. The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise. The terms “a”, “an” and “the” mean “one or more”, unless expressly specified otherwise. Devices that are in communication with each other need not be in continuous communication with each other, unless expressly specified otherwise. In addition, devices that are in communication with each other may communicate directly or indirectly through one or more intermediaries. A description of an embodiment with several components in communication with each other does not imply that all such components are required. On the contrary a variety of optional components are described to illustrate the wide variety of possible embodiments of the present invention.

One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art, in light of these descriptions. Accordingly, it is intended that the present invention embrace all such alternatives, modifications and variations as fall within the scope of the appended claims, and—in particular—all modifications that add known filter circuitry to the input to the invention or to its output. The fact that a product, process or method exhibits differences from one or more of the above-described exemplary embodiments does not mean that the product or process is outside the scope (literal scope and/or other legally-recognized scope) of the following claims. For example, the components of the systems and apparatuses may be integrated or separated. Moreover, the operation of the RF filter and apparatuses disclosed herein may be performed by more, fewer, or other components and the methods described may include more, fewer, or other steps. Additionally, steps may be performed in any suitable order. Any one or more of the foregoing embodiments may well be implemented in silicon, hardware, firmware, software and/or combinations thereof.

The particular illustrated example embodiments are not provided to limit the invention but merely to illustrate it. Thus, the scope of the present invention is not to be determined by the specific examples provided above but only by the plain language of the following claims. To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

1. A radio frequency (RF) filter circuit for suppressing undesired parts and passing desired parts of a spectrum of a multi-frequency radio signal, comprising:
an input port for receiving the signal;
a first mixer coupled to the input port and configured to downconvert the signal to a lower point in the spectrum;
a filter coupled to the first mixer and configured to suppress undesired spectra, noise, and spurious signals and noise in a selected portion of the spectrum of the downconverted signal; and
a second mixer coupled to an output of the filter and configured to upconvert the signal to another selectable point in the spectrum, wherein each of the first and second mixers is coupled to a local oscillator (LO).

2. The RF filter circuit of claim 1, wherein the first and second mixers are coupled to a common LO of controllable frequency.

3. The RF filter circuit of claim 1, wherein the first and second mixers are coupled to a common LO of fixed frequency.

4. The RF filter circuit of claim 1, wherein a notch filter is disposed between the first mixer and the second mixer, the first mixer is controlled to shift the signal to a range of the notch filter, and the second mixer is controlled to shift a resulting notched signal band to an output frequency including an initial input frequency.

5. A circuit comprising at least two RF filter circuits of claim 1 coupled in series,
wherein first and second mixers in a first RF filter circuit and third and fourth mixers in a second RF filter circuit are synchronously controlled by separate LOs;
wherein the first mixer converts a multi-frequency radio signal to a lower point in a spectrum of the signal, at which a first filter cleans one side of the spectrum, the second mixer converts the signal to another point in the spectrum, a BPF cleans distant interferers, the third mixer converts the signal to a lower point in the spectrum with spectral reversal by subtracting the signal from the LO, a second filter of the same type as the first filter cleans the other side of the spectrum, the fourth mixer converts the signal to another point in the spectrum, and a second BPF cleans distant interferers; and
wherein all mixer parameters are determined by synchronous variable LOs.

6. The circuit of claim 5, wherein the spectrum is not reversed, and the first and second filters are different, wherein the signal is converted by the mixers after which each side of the resulting spectrum is cleaned independently.

7. The circuit of claim 6, further comprising a group delay equalizer disposed in one of at least two cells, each cell comprising two mixers, to perform group delay equalization of the signal of interest.

8. An RF filter circuit for suppressing interference in adjacent channels, comprising:
an input port for receiving a multi-frequency radio signal;
a first tunable BPF coupled to the input port and configured to clean distant channels;
first and second signal paths coupled to the first tunable BPF and separating the signal into two signals, the first signal path comprising phase and amplitude adjustment circuits and coupled to a first input of a differential circuit comprised of a second tunable BPF and an amplifier, and the second signal path comprising a first mixer followed by a BPF, a gain control device, a notch filter, and a second mixer to convert the signal back to a range of interest, wherein the second signal path is coupled to a second input of the differential circuit; and
a third tunable BPF and an output amplifier coupled to a combined output of the first and second signal paths with the adjacent channels,
wherein the tunable BPFs and LOs controlling the first and second mixers are synchronously controlled.

9. The RF filter circuit of claim 1, wherein a control unit of the filter is disposed in a closed loop that includes circuitry configured to detect a signal amplitude, phase, and frequency and transmit changes to the control unit, enabling the control unit to dynamically change parameters of the LO based on feedback signals.

10. The RF filter circuit of claim 1, wherein a frequency converter function is provided by using a control signal to change a frequency output from at least one LO applied to at least one mixer to change filter parameters that change an output frequency.

11. A circuit comprising a plurality of RF filter circuits of claim 1 for providing precise bandpass filter functions, comprising at least two of the RF filter circuits having dissimilar arrangements and coupled in series, wherein frequencies of a radio signal are controlled to overlap with filter cutoff frequencies.

12. A circuit comprising a plurality of RF filter circuits of claim 1 for providing precise notch filter functions, comprising at least two of the RF filter circuits having dissimilar arrangements and coupled in series, wherein frequencies of a radio signal are controlled to separate from filter cutoff frequencies.
